(19) United States
(12) Patent Application Publication
(10) Pub. No.: US 2013/0034741 A1
(43) Pub. Date: Feb. 7, 2013

(54) BRANCHED POLYESTER POLYMERS COMPRISING ISOPHTHALIC ACID AND COATINGS COMPRISING THE SAME

(71) Applicants: George W. Mauer, III, Avon Lake, OH (US); Debra Singer, Wexford, PA (US); Susan F. Donaldson, Allison Park, PA (US); John E. Schwendeman, Wexford, PA (US); John M. Furar, Pittsburgh, PA (US); Edward R. Millero, JR., Gibsonia, PA (US); Lawrence J. Fitzgerald, Gibsonia, PA (US); Shanti Swarup, Allison Park, PA (US); Mark A. Tucker, Allison Park, PA (US); Thi Bach-Phuong Dau, Stuttgart (DE); Anthony M. Chasser, Allison Park, PA (US)

(72) Inventors: George W. Mauer, III, Avon Lake, OH (US); Debra Singer, Wexford, PA (US); Susan F. Donaldson, Allison Park, PA (US); John E. Schwendeman, Wexford, PA (US); John M. Furar, Pittsburgh, PA (US); Edward R. Millero, JR., Gibsonia, PA (US); Lawrence J. Fitzgerald, Gibsonia, PA (US); Shanti Swarup, Allison Park, PA (US); Mark A. Tucker, Allison Park, PA (US); Thi Bach-Phuong Dau, Stuttgart (DE); Anthony M. Chasser, Allison Park, PA (US)

(73) Assignee: PPG Industries Ohio, Inc., Cleveland, OH (US)

(21) Appl. No.: 13/197,844

(22) Filed: Aug. 4, 2011

(51) Int. Cl. B32B 27/36; C09D 167/03; C09D 167/00; C08G 63/12; C08G 63/183

(52) U.S. Cl. 428/480; 525/418; 524/601; 524/605; 524/513

(57) ABSTRACT

A branched polyester prepared as the reaction product of a polyacid comprising at least 90 mole % isophthalic acid, including its ester and/or anhydride, and a polyol comprising a tri- or higher-functional polyol is disclosed. Coatings comprising the same are also disclosed, as are substrates coated at least in part with such coatings.

### FIELD OF THE INVENTION

The present invention relates to branched polyesters prepared from isophthalic acid. The present invention further relates to coatings comprising such polyesters and substrates to which such coatings are applied.

### BACKGROUND OF THE INVENTION

Conventional linear and branched polyester resins produced by the polycondensation of different combinations of polyols and polyacids have been widely used in the coatings industry. They have been used to coat a wide range of metallic and non-metallic substrates used in a number of different industries. Particularly suitable examples include substrates used in certain industrial and automotive coatings. Depending upon the substrate and end use, these coatings typically require a particular combination of characteristics, including surface characteristics such as smoothness, gloss, and distinctness of image (“DOI”) and performance characteristics such as chemical resistance, mar resistance, and resistance to weathering.

### SUMMARY OF THE INVENTION

The present invention is directed to branched polyester polymers comprising the reaction product of reactants comprising: a) a polyacid comprising at least 90 mole % isophthalic acid, including its ester and/or anhydride; and b) a polyol comprising a tri- or higher-functional polyol. Coatings, including clear coatings, comprising such branched polyester polymers are also within the scope of the present invention, as are substrates coated at least in part with such coatings.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” means “at least one” unless specifically stated otherwise.

As previously mentioned, the present invention is directed to branched polyester polymers comprising the reaction product of reactants comprising: a) a polyacid comprising at least 90 mole % isophthalic acid, including its ester and/or anhydride; and b) a polyol comprising a tri- or higher-functional polyol. The branched polyester may be dissolved or dispersed in a solvent. Coatings, including clear or tinted coatings, comprising such branched polyester polymers are also within the scope of the present invention, as are substrates coated at least in part with such coatings with or without an underlying basecoat.

As noted above, the branched polyester polymer may be prepared from a polyacid. “Polyacid” and like terms, as used herein, refers to a compound having two or more acid groups and includes the ester and/or anhydride of the acid.

In certain embodiments, the polyacid utilized comprises at least at least 90 mole %, such as at least 95 mole %, and in other embodiments comprises greater than 95 mole %, such as 100 mole %, isophthalic acid, including its ester and/or anhydride.

In certain embodiments, one or more additional acids can also be used. Such acids can include, for example, other polyacids, monoacids, fatty acids, the esters and/or anhydrides of any of these acids and/or combinations thereof. It will be understood by those skilled in the art that a polycarboxylic acid is one that has two or more carboxylic acid functional groups, or residues thereof, such as anhydride groups. Suitable polyacids include but are not limited to saturated polyacids such as adipic acid, azelaic acid, sebacic acid, succinic acid, glutaric acid, decanoic diacid, dodecanoic diacid, cyclohexanedioic acid, hydrogenated C36 dimer fatty acids, and esters and anhydrides thereof. Suitable monoacids include but are not limited to cycloaliphatic carboxylic acids including cyclohexane carboxylic acid, tricyclodecane carboxylic acid, camphoric acid, and aromatic mono carboxylic acids including benzoic acid and t-butylbenzoic acid; C1-C18 aliphatic carboxylic acids such as acetic acid, propanoic acid, butanoic acid, hexanoic acid, oleic acid, linoleic acid, nonanoic acid, undecanoic acid, lauric acid, isononanoic acid, other fatty acids, and those derived from hydrogenated fatty acids of naturally occurring oils such as coconut oil fatty acid; and/or esters and/or anhydrides of any of these. The additional acids comprise, at most, less than 10 mole %, such as no more than 5 mole % of the total acid and polyacids used in forming the branched polyester polymer.

“Monoacid” and like terms, as used herein, refers to a compound having one acid group and includes the ester and/or anhydride of the acid.

In certain other embodiments, the additional monoacid comprises benzoic acid, its ester and/or its anhydride. In certain of these embodiments, the benzoic acid, its ester and/or its anhydride comprises up to 25 weight percent of the total weight of the branched polyester polymer. In certain of these embodiments, the benzoic acid, its ester and/or its anhydride comprises between 5 and 15 weight percent of the total weight of the branched polyester polymer. In certain of these embodiments, the benzoic acid, its ester and/or its anhydride comprises between 10 and 15 weight percent of the total weight of the branched polyester polymer, such as 15 weight percent.

As noted above, the branched polyester polymer may be also prepared from a polyol. “Polyol” and like terms, as used herein, refers to a compound having two or more hydroxyl groups. Polyols can also be chosen to contribute hardness to the branched polyester polymer. Suitable polyols for use in the invention may be any polyols known for making polyesters. Examples include, but are not limited to, alkylene glycols, such as ethylene glycol, propylene glycol, diethylene glycol, dipropylene glycol, triethylene glycol, tripropylene glycol, hexylene glycol, polyethylene glycol, polypropylene glycol and neopentyl glycol; hydrogenated bisphenol A; cyclohexanediol; propanediols including 1,2-propanediol, 1,3-propanediol, butyl ethyl propanediol, 2-methyl-1,3-propanediol, and 2-ethyl-2-butyl-1,3-propanediol; butanediols including 1,4-butanediol, 1,3-butanediol, and 2-ethyl-1,4-butanediol; pentanediols including trimethyl pentanediol and 2-methylpentanediol; 2,2,4-trimethyl-1,3-pentanediol, cyclohexanedimethanol; hexanediols including 1,6-hexanediol; 2-ethyl-1,3-hexanediol, caprolactonediol (for example, the reaction product of epsilon-caprolactone and ethylene glycol); hydroxy-alkylated bisphenols; polyether glycols, for example, poly(oxytetramethylene) glycol; trimethylol propane, di-trimethylol propane, pentaerythritol, di-pentaerythritol, trimethylol ethane, trimethylol butane, dimethylol cyclohexane, glycerol, tris(2-hydroxyethyl)isocyanurate and the like.

During and/or after its formation, the branched polyester of the present invention can be dissolved or dispersed in a single solvent or a mixture of solvents. Any solvent that is typically used during the formation of polyesters may be used, and these will be well known to the person skilled in the art. Typical examples include water, organic solvent(s), and/or mixtures thereof. Suitable organic solvents include but are not limited to glycols, glycol ether alcohols, alcohols, ketones such as: methyl ethyl ketone, methyl isobutyl ketone, and mixtures thereof;

aromatic hydrocarbons, such as xylene and toluene and those available from Exxon-Mobil Chemical Company under the SOLVESSO trade name; acetates including glycol ether acetates, ethyl acetate, n-butyl acetate, n-hexyl acetate, and mixtures thereof; mineral spirits, naphthas and/or mixtures thereof. “Acetates” include the glycol ether acetates. In certain embodiments, the solvent is a non-aqueous solvent. “Non-aqueous solvent” and like terms means that less than 50% of the solvent is water. For example, less than 10%, or even less than 5% or 2%, of the solvent can be water. It will be understood that mixtures of solvents, including or excluding water in an amount of less than 50%, can constitute a “non-aqueous solvent”.

In certain embodiments, the amount of solvent added to disperse or dissolve the branched polyester is such that the branched polyester is between about 30 and 80 weight percent based on resin solids (i.e. where the solvent is between 20 and 70 percent of the total weight of the branched polyester and solvent). In certain embodiments, the amount of solvent added to disperse or dissolve the branched polyester is such that the branched polyester is between about 50 and 70 weight percent, such as 60 weight percent, based on resin solids.

In certain embodiments, the branched polyesters of the invention may have a weight average M_{W} as low as 600, or can have an M_{W} greater than 1000, such as greater than 5000, greater than 10,000, greater than 15,000, greater than 25,000, or greater than 50,000, as determined by gel permeation chromatography using a polystyrene standard. Weight average molecular weights between 2,000 and 6,000 are particularly suitable in some embodiments.

In addition to the molecular weight described above, the branched polyesters of the present invention can also have a relatively high functionality; in some cases the functionality is higher than would be expected for conventional polyesters having such molecular weights. The average functionality of the polyester can be 2.0 or greater, such as 2.5 or greater, 3.0 or greater, or even higher. “Average functionality” as used herein refers to the average number of functional groups on the branched polyester. The functionality of the branched polyester is measured by the number of hydroxyl groups that remain unreacted in the branched polyester, and not by the unreacted unsaturation. In certain embodiments, the hydroxyl value of the branched polyesters of the present invention can be from 10 to 500 mg KOH/gm, such as 30 to 250 mg KOH/gm.

In certain embodiments, the branched polyester comprises the reaction product of reactants comprising, based on the total weight of the polyester, 5 to 50 weight percent of 2-methyl-1,3-propane diol, 5 to 60 weight percent neopentyl glycol, 5 to 70 weight percent isophthalic acid, and 5 to 40 weight percent trimethylolpropane, where the mole percent ratio of diol and glycol components are above 51% and the mole ratio of alcohol equivalents to carboxyl equivalents is between 1.03 and 1.15. The weight average molecular weight, as determined by gel permeation chromatography using a polystyrene standard, is preferably between about 2,000 and 6,000. In certain of these embodiments, the branched polyester is reduced to between 30 and 80 percent resin solids (i.e. the solvent comprises between 20 and 70 percent, by weight, of the total weight of the branched polyester) by addition of a solvent or a mixture of solvents.

In certain embodiments, the branched polyester comprises the reaction product of reactants comprising, based on the total weight of the reactants: (a) 5-70 weight % dicarboxylic acid, wherein at least 90 mole % of the dicarboxylic acid comprises isophthalic acid; and (b) 5-50 weight % polyol, wherein 1-99 weight % of the polyol comprises an asymmetric diol and wherein the remainder of the polyol comprises a tri- or higher-functional polyol. In certain of these embodiments, the branched polyester is reduced to between 30 and 80 percent resin solids by addition of a solvent or a mixture of solvents.

In certain embodiments, the branched polyester comprises the reaction product of reactants comprising, based on the total weight of the reactants: (a) 5-70% dicarboxylic acid, wherein at least 90 mole % of the dicarboxylic acid comprises isophthalic acid; (b) 5-50% polyol, wherein 1-99% of the polyol comprises an asymmetric diol and wherein the remainder of the polyol comprises a tri- or higher-functional polyol; and (c) 1-30% of a monoacid. In certain related embodiments, the monacid comprises benzoic acid. In certain of these embodiments, the branched polyester is reduced to between 30 and 80 weight percent of the total weight of the branched polyester by addition of a solvent or a mixture of solvents (i.e. wherein the solvent and/or mixture of solvents comprises between 20 and 70 weight percent of the total weight of the polyester and solvents).

Because the branched polyester of the present invention comprises functionality, it is suitable for use in coating formulations in which the hydroxyl groups (and/or other functionality) are crosslinked with other resins and/or crosslinkers typically used in coating formulations. Thus, the present invention is further directed to a coating comprising a branched polyester according to the present invention and a crosslinker. The crosslinker, or crosslinking resin or agent, can be any suitable crosslinker or crosslinking resin known in the art, and will be chosen to be reactive with the functional group or groups on the polyester. It will be appreciated that the coatings of the present invention cure through the reaction of the hydroxyl groups and/or other functionality and the crosslinker and not through the double bonds of the polycarboxylic acid/anhydride/ester moiety, to the extent any such unsaturation exists in the branched polyester.

Non-limiting examples of suitable crosslinkers include phenolic resins, amino resins, epoxy resins, isocyanate resins, beta-hydroxy (alkyl) amide resins, alkylated carbamate resins, polyacids, anhydrides, organometallic acid-functional materials, polyamines, polyamides, aminoplasts and mixtures thereof. In certain embodiments, the crosslinker is a phenolic resin comprising an alkylated phenol/formaldehyde resin with a functionality ≧3 and difunctional o-cresol/formaldehyde resins. Such crosslinkers are commercially available from Hexion as BAKELITE 6520LB and BAKELITE 7081LB.

Suitable isocyanates include multifunctional isocyanates. Examples of multifunctional polyisocyanates include aliphatic diisocyanates like hexamethylene diisocyanate and isophorone diisocyanate, and aromatic diisocyanates like toluene diisocyanate and 4,4′-diphenylmethane diisocyanate. The polyisocyanates can be blocked or unblocked. Examples of other suitable polyisocyanates include isocyanurate trimers, allophanates, and uretdiones of diisocyanates and polycarbodiimides such as those disclosed in U.S. patent application Ser. No. 12/056,304 filed Mar. 27, 2008, incorporated by reference in pertinent part herein. Suitable polyisocyanates are well known in the art and widely available commercially. For example, suitable polyisocyanates are disclosed in U.S. Pat. No. 6,316,119 at columns 6, lines 19-36, incorporated by reference herein. Examples of commercially available polyisocyanates include DESMODUR VP2078 and DESMODUR N3390, which are sold by Bayer Corporation, and TOLONATE HDT90, which is sold by Perstorp.

Suitable aminoplasts include condensates of amines and/or amides with aldehyde. For example, the condensate of melamine with formaldehyde is a suitable aminoplast. Suitable aminoplasts are well known in the art. A suitable aminoplast is disclosed, for example, in U.S. Pat. No. 6,316,119 at column 5, lines 45-55, incorporated by reference herein.

In preparing the present coatings, the branched polyester and the crosslinker can be dissolved or dispersed in a single solvent or a mixture of solvents. Any solvent that will enable the formulation to be coated on a substrate may be used, and these will be well known to the person skilled in the art. Suitable organic solvents include but are not limited to glycols, glycol ether alcohols, alcohols, ketones such as: methyl ethyl ketone, methyl isobutyl ketone, and mixtures thereof; aromatic hydrocarbons, such as xylene and toluene and those available from Exxon-Mobil Chemical Company under the SOLVESSO trade name; acetates including glycol ether acetates, ethyl acetate, n-butyl acetate, n-hexyl acetate, and mixtures thereof; mineral spirits, naphthas and/or mixtures thereof. “Acetates” include the glycol ether acetates. In certain embodiments, the solvent is a non-aqueous solvent. “Non-aqueous solvent” and like terms means that less than 50 weight % of the solvent is water, based on the total solvent weight. For example, less than 10 weight %, or even less than 5 weight % or 2 weight %, of the solvent can be water. It will be understood that mixtures of solvents, including or excluding water in an amount of less than 50 weight %, based on the total solvent weight, can constitute a “non-aqueous solvent”.

In certain embodiments, the coatings of the present invention further comprise a curing catalyst. Any curing catalyst typically used to catalyze crosslinking reactions between polyester resins and crosslinkers, such as phenolic resins, may be used, and there are no particular limitations on the catalyst. Examples of such a curing catalyst include phosphoric acid, alkyl aryl sulphonic acid, dodecyl benzene sulphonic acid, dinonyl naphthalene sulphonic acid, and dinonyl naphthalene disulphonic acid.

If desired, the coating compositions can comprise other optional materials well known in the art of formulating coatings in any of the components, such as colorants, plasticizers, abrasion resistant particles, anti-oxidants, hindered amine light stabilizers, UV light absorbers and stabilizers, surfactants, flow control agents, thixotropic agents, fillers, organic cosolvents, reactive diluents, catalysts, grind vehicles, and other customary auxiliaries.

It will be appreciated that the polyester of the present invention and crosslinker therefore can form all or part of the film-forming resin of the coating. In certain embodiments, one or more additional film-forming resins are also used in the coating. For example, the coating compositions can comprise any of a variety of thermoplastic and/or thermosetting compositions known in the art. The coating compositions may be water-based or solvent-based liquid compositions, or alternatively, may be in solid particulate form, i.e. a powder coating.

Thermosetting or curable coating compositions may also comprise additional film-forming polymers or resins having functional groups that are reactive with either themselves or a crosslinking agent. The additional film-forming resin can be selected from, for example, acrylic polymers, polyester polymers, polyurethane polymers, polyamide polymers, polyether polymers, polysiloxane polymers, copolymers thereof, and mixtures thereof. Generally, these polymers can be any polymers of these types made by any method known to those skilled in the art. Such polymers may be solvent-borne or water-dispersible, emulsifiable, or of limited water solubility. The functional groups on the film-forming resin may be selected from any of a variety of reactive functional groups including, for example, carboxylic acid groups, amine groups, epoxide groups, hydroxyl groups, thiol groups, carbamate groups, amide groups, urea groups, isocyanate groups (including blocked isocyanate groups) mercaptan groups, and combinations thereof. Appropriate mixtures of film-forming resins may also be used in the preparation of the present coating compositions. In certain embodiments, wherein the film-forming resin comprises an acrylic polymer such as a acrylic polyol polymer, the amount of acrylic polyol polymer may be less than 55 percent by weight of the total solids weight of the coating composition.

The coating composition may optionally contain an additional polyol polymer or oligomer different from the additional film-forming polymers or resins described in the previous paragraph. In certain embodiments, wherein the film-forming resin comprises an acrylic polymer such as a acrylic polyol polymer and an additional polyol polymer different from the acrylic polyol polymer, the total of acrylic polyol polymer and additional polyol polymer may be between about 1 and about 70 percent by weight, based on the total solids weight of the coating composition.

The acrylic polymers are copolymers of one or more alkyl esters of acrylic acid or methacrylic acid optionally together with one or more other polymerizable ethylenically unsaturated monomers. Suitable alkyl esters of acrylic acid or methacrylic acid include aliphatic alkyl esters containing from 1-30, preferably 4-18 carbon atoms in the alkyl group. Examples include methyl methacrylate, ethyl methacrylate, butyl methacrylate, ethyl acrylate, butyl acrylate, 2-ethylhexyl acrylate and 2-ethylhexyl methacrylate. Suitable other copolymerizable ethylenically unsaturated monomers include vinyl aromatic compounds such as styrene which is preferred and vinyl toluene; nitrites such acrylonitrile and methacrylonitrile; vinyl and vinylidene halides such as vinyl chloride and vinylidene fluoride and vinyl esters such as vinyl acetate.

Hydroxyl functional groups are most often incorporated into the polymer by using functional monomers such as hydroxyalkyl acrylates and methacrylates, having 2 to 4 carbon atoms in the hydroxy-alkyl group including hydroxyethyl acrylate, hydroxyethyl methacrylate, hydroxypropyl acrylate, hydroxypropyl methacrylate, 4-hydroxybutyl acrylate, 4-hydroxybutyl methacrylate and the like. Also hydroxy functional adducts of caprolactone and hydroxyalkyl acrylates and methacrylates. Mixtures of these hydroxyalkyl functional monomers may also be used. The acrylic polyol polymer can be prepared by solution polymerization techniques. In conducting the reaction, the monomers are heated, typically in the presence of a free radical initiator and optionally a chain transfer agent, in an organic solvent in which the ingredients as well as the resultant polymer product are compatible. Typically, the organic solvent is charged to a reaction vessel and heated to reflux, optionally under an inert atmosphere. The monomers and other free radical initiator are added slowly to the refluxing reaction mixture. After the addition is complete, some additional initiator may be added and the reaction mixture held at an elevated temperature to complete the reaction.

The acrylic polymer used in the film-forming composition typically has a weight average molecular weight of about 2,000 to about 25,000, preferably 3,000 to 10,000 as determined by gel permeation chromatography using a polystyrene standard. The hydroxyl equivalent weight of the polymer is generally about 200 to about 800, preferably about 300 to about 500.

Thermosetting coating compositions typically comprise a crosslinking agent that may be selected from any of the crosslinkers described above. In certain embodiments, the present coatings comprise a thermosetting film-forming polymer or resin and a crosslinking agent therefor and the crosslinker is either the same or different from the crosslinker that is used to crosslink the polyester. In certain other embodiments, a thermosetting film-forming polymer or resin having functional groups that are reactive with themselves are used; in this manner, such thermosetting coatings are self-crosslinking.

The coatings of the present invention may comprise 1 to 100 weight %, such as 10 to 90 weight % or 20 to 80 weight %, with weight % based on total solid weight of the coating composition, of the polyester of the present invention. The coating compositions of the present invention may also comprise 0 to 90 weight %, such as 5 to 60 weight % or 10 to 40 weight %, with weight % based on total solids weight of the coating composition, of a crosslinker for the branched polyester. Additional components, if used, may comprise 1 weight %, up to 70 weight %, or higher, with weight % based on total solids weight of the coating composition.

In certain embodiments, the coating composition comprises: (1) 55-85 weight % of a polyester comprising the reaction product of reactants comprising: (a) polyacid comprising at least 90 mole % isophthalic acid, including its ester and/or anhydride; (b) a polyol comprising at least one tri- or higher-functional polyol; and (c) a solvent; and (2) 15-45 weight % coreactive aminoplast or isocyanate crosslinking agent adapted to crosslink with the polyester, wherein the weight percentages are based on the total solids weight of the coating composition.

In certain embodiments, the coating composition comprises a thermosetting binder comprising between 60 weight % and 95 weight %, such as between 80 weight % and 95 weight %, of this branched polyester polymer in combination with between 40 weight % and 5 weight %, such as between 20 weight % and 5 weight%, coreactive aminoplast or isocyanate crosslinking agent adapted to crosslink with the polyester, wherein the weight percentages are based on the total solids weight of the coating composition.

The present coatings can be applied to any substrates known in the art, for example, automotive substrates, industrial substrates, packaging substrates, wood flooring and furniture, apparel, electronics including housings and circuit boards, glass and transparencies, sports equipment including golf balls, and the like. These substrates can be, for example, metallic or non-metallic. Metallic substrates include tin, steel, tin-plated steel, chromium passivated steel, galvanized steel, aluminum, aluminum foil. Non-metallic substrates include polymeric, plastic, polyester, polyolefin, polyamide, cellulosic, polystyrene, polyacrylic, poly(ethylene naphthalate), polypropylene, polyethylene, nylon, EVOH, polylactic acid, other “green” polymeric substrates, poly(ethyleneterephthalate) (“PET”), polycarbonate, polycarbonate acrylobutadiene styrene (“PC/ABS”), polyamide, wood, veneer, wood composite, particle board, medium density fiberboard, cement, stone, glass, paper, cardboard, textiles, leather both synthetic and natural, and the like. The substrate can be one that has been already treated in some manner, such as to impart visual and/or color effect.

The coatings of the present invention can be applied by any means standard in the art, such as electrocoating, spraying, electrostatic spraying, dipping, rolling, brushing, and the like.

The coatings can be applied to a dry film thickness of 0.04 mils to 4 mils, such as 0.3 to 2 or 0.7 to 1.3 mils. In other embodiments the coatings can be applied to a dry film thickness of 0.1 mils or greater, 0.5 mils or greater 1.0 mils or greater, 2.0 mils or greater, 5.0 mils or greater, or even thicker. The coatings of the present invention can be used alone, or in combination with one or more other coatings. For example, the coatings of the present invention can comprise a colorant or not and can be used as a primer, basecoat, and/or top coat. For substrates coated with multiple coatings, one or more of those coatings can be coatings as described herein. The present coatings can also be used as a packaging “size” coating, wash coat, spray coat, end coat, and the like.

It will be appreciated that the coatings described herein can be either one component (“1K”), or multi-component compositions such as two component (“2K”) or more. A 1K composition will be understood as referring to a composition wherein all the coating components are maintained in the same container after manufacture, during storage, etc. A 1K coating can be applied to a substrate and cured by any conventional means, such as by heating, forced air, and the like. The present coatings can also be multi-component coatings, which will be understood as coatings in which various components are maintained separately until just prior to application. As noted above, the present coatings can be thermoplastic or thermosetting.

In certain embodiments, the coating is a clearcoat. A clearcoat will be understood as a coating that is substantially transparent. A clearcoat can therefore have some degree of color, provided it does not make the clearcoat opaque or otherwise affect, to any significant degree, the ability to see the underlying substrate. The clearcoats of the present invention can be used, for example, in conjunction with a pigmented basecoat. The clearcoat can be formulated as is know in the coatings art.

### EXAMPLES

### Part A—Preparation of Polyesters for Evaluation

### Example 1

A polyester was prepared by adding a total of 104 grams of trimethylol propane, 231 grams of neopentyl glycol, 231 grams of 2-methyl-1,3-propanediol, 784 grams of isophthalic acid, 0.7 grams of di-butyl tin oxide and 1.4 grams of triphenyl phosphite to a suitable reaction vessel equipped with a stirrer, temperature probe, a glycol recovery distillation setup (packed column with empty column on top and distillation head connected to a water cooled condenser), and a nitrogen sparge. The contents of the reactor were gradually heated to 230° C. Water began to evolve from the reaction at about 206° C. The temperature of the reaction mixture was held at 230° C. until about 154 grams of water had been collected and the acid value of the reaction mixture was 5.4 mg KOH/g sample. The contents of the reactor were cooled to 123° C. then thinned to 65% theory solids with 510 grams of Solvesso 100 (available from Exxon) followed by 128 grams of 2-butoxyethanol, and the mixture was poured out. The final resin solution had a measured solids (110° C./1 hour) of about 65.6%, a Gardner-Holt viscosity of Z, an acid value of 3.4 mg KOH/g sample, and a hydroxyl value of 108.1 mg KOH/g sample. Gel permeation chromatography was used with tetrahydrofuran solvent and polystyrene standards to determine a weight average molecular weight of 4907.

### Example 2

A polyester was prepared by adding a total of 360 grams of trimethylol propane, 360 grams of neopentyl glycol, 360 grams of 2-methyl-1,3-propanediol, 1319 grams of isophthalic acid, 402 grams of benzoic acid, 1.4 grams of di-butyl tin oxide and 2.8 grams of triphenyl phosphite to a suitable reaction vessel equipped with a stirrer, temperature probe, a glycol recovery distillation setup (packed column with empty column on top and distillation head connected to a water cooled condenser), and a nitrogen sparge. The contents of the reactor were gradually heated to 230° C. Water began to evolve from the reaction at about 195° C. The temperature of the reaction mixture was held at 230° C. until about 297 grams of water had been collected and the acid value of the reaction mixture was 8.6 mg KOH/g sample. The contents of the reactor were cooled to 148° C. then thinned to 65% theory solids with 929 grams of Solvesso 100 (available from Exxon) followed by 398 grams of Dowanol PM acetate, and the mixture was poured out. The final resin solution had a measured solids (110° C./1 hour) of about 64.0%, a Gardner-Holt viscosity of U-V, an acid value of 5.6 mg KOH/g sample, and a hydroxyl value of 56.5 mg KOH/g sample. Gel permeation chromatography was used with tetrahydrofuran solvent and polystyrene standards to determine a weight average molecular weight of 3331.

### Example 3

A polyester was prepared by adding a total of 102 grams of neopentyl glycol, 390 grams of 2-methyl-1,3-propanediol, 678 grams of isophthalic acid, 130 grams of adipic acid, and 0.46 grams of butylstannoic acid to a suitable reaction vessel equipped with a stirrer, temperature probe, a glycol recovery distillation setup (packed column with empty column on top and distillation head connected to a water cooled condenser), and a nitrogen sparge. The contents of the reactor were gradually heated to 210° C. Water began to evolve from the reaction at about 180° C. The temperature of the reaction mixture was held at 210° C. until about 158 grams of water had been collected and the acid value of the reaction mixture was 7.8 mg KOH/g sample. The contents of the reactor were cooled to 108° C. then thinned to 62% theory solids with 517 grams of Solvesso 150 (available from Exxon) followed by 172 grams of Dowanol PM acetate, and the mixture was poured out. The final resin solution had a measured solids (110° C./1 hour) of about 61.5%, a Gardner-Holt viscosity of X-Y, an acid value of 4.3 mg KOH/g sample, and a hydroxyl value of 22.3 mg KOH/g sample. Gel permeation chromatography was used with tetrahydrofuran solvent and polystyrene standards to determine a weight average molecular weight of 6751.

### Example 4

A polyester was prepared by adding a total of 207 grams of trimethylol propane, 452 grams of neopentyl glycol, 452 grams of 2-methyl-1,3-propanediol, 1223 grams of isophthalic acid, 366 grams of adipic acid, 1.4 grams of di-butyl tin oxide and 2.7 grams of triphenyl phosphite to a suitable reaction vessel equipped with a stirrer, temperature probe, a glycol recovery distillation setup (packed column with empty column on top and distillation head connected to a water cooled condenser), and a nitrogen sparge. The contents of the reactor were gradually heated to 230° C. Water began to evolve from the reaction at about 167° C. The temperature of the reaction mixture was held at 230° C. until about 348 mL of water had been collected and the acid value of the reaction mixture was 10.8 mg KOH/g sample. The contents of the reactor were cooled to 148° C. then thinned to 65% theory solids with 1015 grams of Solvesso 150 (available from Exxon) and 254 grams of Butyl Cellosolve (available from Dow Chemical Co.), and the mixture was poured out. The final resin solution had a measured solids (110° C./1 hour) of about 64.6%, a Gardner-Holt viscosity of Z2+, an acid value of 6.2 mg KOH/g sample, and a hydroxyl value of 85.3 mg KOH/g sample Gel permeation chromatography was used with tetrahydrofuran solvent and polystyrene standards to determine a weight average molecular weight of 11,509.

### Part B—Preparation of Clearcoats for Evaluation

Next, clearcoat compositions were prepared from the polyesters from Part A as shown below in Table 1:

TABLE 1

| | Example 5 | | Example 6 | | Example 7 | | Example 8 | | Example 9 | |
|---|---|---|---|---|---|---|---|---|---|---|
| | Clearcoat | | Clearcoat | | Clearcoat | | Clearcoat | | Clearcoat | |
| Example 1 | 100 | g | | | | | | | 47 | g |
| Polyester | | | | | | | | | | |
| Example 2 | | | 100 | g | | | | | | |
| Polyester | | | | | | | | | | |
| Example 3 | | | | | 100 | g | | | | |
| Polyester | | | | | | | | | | |
| Example 4 | | | | | | | 100 | g | | |
| Polyester | | | | | | | | | | |
| US 138¹ | 54 | g | 54 | g | 54 | g | 54 | g | | |
| (Melamine) | | | | | | | | | | |
| Acrylic | | | | | | | | | 53 | g |
| Polyol⁸ | | | | | | | | | | |
| Cymel 202⁷ | | | | | | | | | 32 | g |
| DDBSA² | 1 | g | 1 | g | 1 | g | 1 | g | 0.8 | g |
| (Catalyst) | | | | | | | | | | |
| RCH 8794⁴ | 1 | g | 1 | g | 1 | g | 1 | g | 0.8 | |
| (Modaflow) | | | | | | | | | | |
| PM | 10 | g | 10 | g | 10 | g | 10 | g | 10 | g |
| Acetate | | | | | | | | | | |
| (Solvent)³ | | | | | | | | | | |
| Aromatic | 10 | g | 10 | g | 10 | g | 10 | g | 10 | g |
| 100⁵ | | | | | | | | | | |
| (Solvent) | | | | | | | | | | |
| Tridecyl | 2 | g | 2 | g | 2 | g | 2 | g | 2 | g |
| alcohol⁶ | | | | | | | | | | |
| (slow | | | | | | | | | | |
| solvent) | | | | | | | | | | |

¹US 138—metholyated melamine available from Cytec Industries
²DDBSA—sulfonic acid catalyst for melamine available from Cytec Industries
Available from Dow Chemical Company
Available from Exxon Corporation
⁴Poly(Butyl Acrylate) flow additive available from DuPont
⁶Solvent available from Degussa Corp
⁷Cymel 202 is a melamine composition commercially available from Cytec Industries
⁸Acrylic Polyol is described in U.S. Pat. No. 5,965,670, Appendix 1, Example A as containing hydroxyl groups derived from hydroxyethyl methacrylate and an adduct of acrylic acid and glycidyl neodeconoate.

The above clearcoats are made by first combining all solvents to a suitably sized container and then under mild agitation, adding in order, polyester, melamine, catalyst and then Modaflow.

Example 9 adds an acrylic polymer blend to the clearcoat composition. The formulation in Example 9 has been slightly adjusted to account for different viscosities of the starting raw materials.

### Part C—Evaluation of Clearcoats in Multilayer Coating Systems

Next, the clearcoat compositions from Part B were evaluated in multilayer coating systems applied onto a steel substrate material. The results are summarized in Table 2 below.

The clearcoats were spray applied using a SPRAYMATION machine onto 4 inch by 12 inch steel panels coated with cured ELECTROCOAT (ED 6060)/PPG HP77224ER Primer available from ACT Test Panels, Inc. of Hillsdale, Mich. A waterborne black color coat (HWH-9517), available from PPG Industries, was spray applied onto the E-Coat panels with a total dry film thickness of 0.5 mils before application of the clear. The waterborne black color coat was dehydrated for ten minutes at 176° F. before clear application. After clear application and a ten minute room temperature flash, the entire layering system was baked for thirty minutes at 285° F.

Dry film thickness measured using FISCHER DELTACOPE made by FISCHER TECHNOLOGY, INC. of Windsor, Conn.

Gloss was measured using a NOVO GLOSS statistical 20° Glossmeter available from Paul N. Gardner Company, Inc. of Pompano Beach, Fla.

Microhardness was measured using a microhardness instrument available from Helmut Fischer GMBH & Company of Sindelfingen, Germany. A 400 microliter drop of 38% Sulfuric Acid was placed on each panel for three days and the resulting damage was recorded. The rating scale is: 0=OK/1=Light Ring/2=Ring/3=Light whitening and/or blistering/4=white & swollen, matte, strong blistering/5=total damage.

Acid testing was done using GM Opel (GM 60409) test, in which a 400 microliter drop of 38% Sulfuric Acid was placed on each panel for three days and the resulting damage recorded. The rating scale is: 0=OK/1=Light Ring/2=Ring/3=Light whitening and/or blistering/4=white & swollen, matte, strong blistering/5=total damage.

Mar testing was done using an Atlas AATCC Scratch Tester Model CM-5 (electric powered version), available from Atlas Electrical Devices Co., 4114 N. Ravenswood Ave., Chicago, Ill. 60613. Nine micron wet or dry abrasive paper available from 3M Corp (3M Center Bldg., 251-2A-08, St. Paul, Minn. 55144-1000 Telephone: (800) 533-6419) is cut into two inch by two-inch squares and the paper is controllably run back and forth on the panel for 10 times. Percent retention was expressed as the percentage of the 20° Gloss retained after the surface was scratched by the scratch tester.

Scratch Resistance=(Scratch Gloss/Original Gloss)×100.

TABLE 2

| | | | Opel Etch | | | | | | |
|---|---|---|---|---|---|---|---|---|---|
| | | | Test² | | 5000 hrs | MEK | | | |
| | Formula | | (1 good → | WOM³ | 340 | double | Mandrel | Gloss⁵ | 9μ |
| | description | FMH¹ | 4 Poor) | 5000 hrs | QUV | rubs | Bend⁴ | 20/60 | Mar⁶ |
| Example | High IPA | 185 | 1 | 100% | 95% | +200 | 50 mm | 100/101 | 35% |
| 5 | containing | | | retention | retention | | | | |
| Clearcoat | polyester | | | | | | | | |
| Example | Polyester with | 185 | 1 | 100% | 100% | +200 | 50 mm | 99/100 | 30% |
| 6 | Benzoic Acid | | | retention | retention | | | | |
| Clearcoat | incorporation | | | | | | | | |
| Example | Linear | 85 | 4 | 85% | 88% | +50 | 00 mm | 98/99 | 40% |
| 7 | Polyester | | | retention | retention | | | | |
| Clearcoat | | | | | | | | | |
| Example | Branched IPA | 80 | 4 | Retired at | Retired at | 200 | 0 mm | 81/87 | 40% |
| 8 | polyester with | | | 2000 | 2000 | | | | |
| Clearcoat | reduced | | | hours⁸ | hours⁹ | | | | |
| | amount of | | | | | | | | |
| | IPA | | | | | | | | |
| Example | Acrylic Blend | 130 | 2 | 100% | 100% | +200 | 50 mm | 97/98 | 48% |
| 9 | with IPA | | | retention¹⁰ | retention | | | | |
| Clearcoat | polyester | | | | | | | | |
| Example | Conventional | 120 | 2 | 100% | 100% | +200 | 50 mm | 89/85 | 40% |
| 10—Auto | Acrylic | | | retention | retention | | | | |
| Europa | | | | | | | | | |
| Clear⁷ | | | | | | | | | |

¹Microhardness Instrument available from Helmut Fischer GMBH & Company of Sindelfingen, Germany.
²Opel test method is GM Engineering standard test method GME 60409.
³WOM results recorded in % retention of gloss.
⁴Mandrel Bend test ASTM D 522-93a (Method A) Standard Test Method for Mandrel Bend Test of Attached Organic Coatings.
⁵Gloss readings recorded on black water-borne basecoat—HWH9517.
⁶Atlas Mar Test—9μ, 3M paper.
⁷Auto Europa Clear is a standard acrylic automotive clearcoat.
⁸At 2000 hours, the coating retained 0% of its original gloss.
⁹At 2000 hours, the coating retained 0% of its original gloss.
¹⁰Test results based on 3500 hours of WOM.

Table 6 confirms that multilayer coating systems having a clearcoat formed in accordance with Example 5 (utilizing the polyester formed in Example 1) exhibited excellent gloss retention and Acid resistance (GM Opel etch testing).

Table 6 also confirms that multilayer coating systems having a clearcoat formed in accordance with Example 6 (utilizing Benzoic acid formed in Example 2) had high Fischer MicroHardness values. These coatings formed acceptable coatings exhibiting excellent initial gloss, gloss retention, and etch resistance.

Table 6 confirms that multilayer coating systems having a clearcoat formed in accordance with Example 7 (utilizing the linear polyester formed in Example 3) exhibited good initial gloss, acceptable gloss retention and scratch resistance but were unacceptable as the chemical resistance of this coating was poor (as seen in the Opel etch testing and MEK double rubs. These clearcoats have reduced crosslinking density and hence poor resultant chemical resistance. Coatings exhibiting poor acid etch, poor MEK or solvent resistance are known to badly water spot in the field and will be damaged by gasoline spilling in the fueling process, as well as showing bird spot, tree sap and related damage in actual field testing. Automobile manufactures use acid etch testing, referenced above, and MEK or gasoline resistance as litmus tests for field performance. A coating without adequate chemical resistance is unacceptable for actual field use.

Table 6 also confirms that multilayer coating systems having a clearcoat formed in accordance with Example 8 (utilizing the polyester formed in Example 4), which include acids other than isophthalic acid (here adipic acid) and hence lower isophthalic acid content, exhibited softer films (low high Fischer MicroHardness values). Chemical resistance was also compromised as seen by the poor etch testing. In addition, the clearcoat panels exhibited very poor performance in accelerated UV testing (WOM results as described above). Further, the films were so badly water spotted that gloss retention was impossible to measure, a fact which was confirmed independently with subsequent Florida exposure panels.

Table 6 also confirms that the inclusion of acrylics to the clearcoats to modify the clearcoat of Example 5 (as shown in Example 9) exhibited high Fischer MicroHardness values, excellent initial gloss, good gloss retention, and good etch resistance similar to the panels of Example 5.

Lastly an example of an acrylic coating used by several European automobile manufactures is shown in Table 6, Example 10. This coating is a benchmark for automotive clearcoats—a coating which has poorer UV durability or poorer chemical resistance would not be appropriate for use as an automotive clearcoat.

Whereas particular embodiments of this invention have been described above for purposes of illustration, it will be evident to those skilled in the art that numerous variations of the details of the present invention may be made without departing from the invention as defined in the appended claims.

What is claimed is:

1. A branched polyester polymer comprising a reaction product of reactants comprising:
a) a polyacid comprising at least 90 mole % isophthalic acid, including its ester and/or anhydride; and
b) a polyol comprising a tri- or higher-functional polyol.

2. The branched polyester polymer of claim 1, wherein the reactants further comprise (c) a monoacid.

3. The branched polyester polymer of claim 1, wherein said monoacid (c) comprises benzoic acid.

4. The branched polyester polymer of claim 1, wherein said polyol (b) further comprises an asymmetric diol.

5. The branched polyester polymer of claim 4, wherein said asymmetric diol comprises 2-methyl-1,3-propanediol and/or neopentyl glycol.

6. The branched polyester polymer of claim 5, wherein said tri- or higher-functional polyol comprises trimethylolpropane.

7. The branched polyester polymer of claim 1, wherein said polyacid comprises from 5 to 70 weight % and said polyol comprises from 5 to 50 weight %, based on the total weight of said reactants.

8. The branched polyester polymer of claim 2, wherein said polyacid comprises from 5 to 70 weight %, said polyol comprises from 5 to 50 weight %, and said monoacid comprises from 1 to 30 weight %, based on the total weight of said reactants.

9. The branched polyester polymer of claim 1, wherein the M_{W} of said branched polyester polymer is 2,000 to 6,000.

10. A coating composition comprising said branched polyester polymer of claim 1 and a crosslinker.

11. A substrate coated at least in part with the coating composition of claim 10.

12. The substrate of claim 11, wherein said coating layer comprises a clearcoat.

13. A coating composition comprising:
(a) a crosslinker; and
(b) a branched polyester polymer comprising a reaction product of reactants comprising (1) a polyacid comprising at least 90 mole % isophthalic acid, including its ester and/or anhydride; and (2) a polyol comprising at least one at least one tri- or higher-functional polyol.

14. The coating composition of claim 13, wherein said reactants further comprise (3) a monoacid.

15. The coating composition of claim 14, wherein said monoacid comprises benzoic acid.

16. The coating composition of claim 13, wherein said polyol (2) further comprises an asymmetric diol.

17. The coating composition of claim 13 further comprising (c) an acrylic polymer.

18. A multilayer coated substrate comprising:
a substrate;
a basecoat applied to said substrate; and
a clearcoat applied to said basecoat, said clearcoat deposited from a coating composition comprising:
(a) a crosslinker; and
(b) a branched polyester polymer comprising a reaction product of reactants comprising (1) a polyacid comprising at least 90 mole % isophthalic acid, including its ester and/or anhydride; and (2) a polyol comprising at least one at least one tri- or higher-functional polyol.

19. The multilayer coated substrate of claim 18, wherein said reactants further comprise (3) benzoic acid.

20. The multilayer coated substrate of claim 19, wherein said coating composition further comprising (c) an acrylic polymer.
